(19) United States
(12) Patent Application Publication
(10) Pub. No.: US 2009/0187125 A1
(43) Pub. Date: Jul. 23, 2009

(54) GAMING MACHINE AND METHOD OF USE THEREOF

(76) Inventors: Ton Tran, Tucker, GA (US); Vien Le, Lawrenceville, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/015,850

(22) Filed: Jan. 17, 2008

(51) Int. Cl. A61H 1/00; A63F 9/24

(52) U.S. Cl. 601/49; 463/31

(57) ABSTRACT

A gaming machine having a gaming machine enclosed within a massage chair and a gaming display attached to the massage chair via a rotating mount or is projected holographically. The gaming machine has a gaming computer, control button panel, an input/output panel and a money dispenser, all of which are in electrical communication. Further, the gaming machine comprises a reclinable seatback, footrest and at least one armrest, each having motorized massage mechanisms. To use, the player sits in the massage chair and places his/her legs into the left and right leg groove, respectively. The player plays a game by pressing buttons on the control panel and collects game winnings, if applicable, from the dispenser box or by addition of credits to an account card. The gaming machine further comprises a second display of the current jackpot.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to a gaming machine, and more specifically to a gaming machine enclosed within a massage chair, wherein a gaming display is attached to the massage chair via a rotating mount or is projected holographically.

2. Description of Related Art

Typically, game machines such as, slot machines, are utilized by players for an extended period of time. Players either stand or sit in uncomfortable chairs or on stools while playing game machines, and such standing or sitting can cause discomfort in a player's shoulder, neck, arms, back and/or legs. Such discomfort can affect posture, and continued sitting or standing can lead to serious heath problems, such as chronic back pain and/or cramps.

Typically, gaming machines consist of a gaming display, a gaming apparatus and buttons on the game machine. However, most gaming machines are not attached to a comfortable sitting unit. Most casinos, bars, lounges or other gaming establishments only place stools or uncomfortable chairs next to gaming machines for users to sit on while playing the gaming machine.

Unfortunately, because of discomfort, a player will often spend less time playing a gaming machine than she/he would otherwise desire and must often walk away from the gaming machine to stretch and/or exercise to recover from the discomfort and/or stress. Further, casino operators would prefer a patron utilize their slot machine and/or similar gaming devices to the maximum time available. Such increased usage would result in higher profits to the gambling establishment.

One method of relieving stress and discomfort is through the manipulation or massaging of muscles, joints and even bone structure. While this is most often carried out by a masseur or masseuse, modern technology has been applied to remove the need for hiring someone to perform a massage via mechanical means.

One such device utilized is a massage chair or chair mat. The latter is a separate massaging mat or cushion that can be placed in any chair to knead a person's back. Such a device is of limited applicability as it only massages the back of the seated person.

Massage chairs consist of a reclinable seatback and footrest. Most massage chairs incorporate massage mechanisms within their structure to massage a user's body. While massage chairs do provide relaxation and comfort, they do not incorporate entertainment, such as a gaming mechanism and gaming display within or as part of the massage chair.

Therefore, it is readily apparent that there is a need for a gaming device in which a player can sit in a comfortable and relaxing position while also being able to play the gaming device.

### BRIEF SUMMARY OF THE INVENTION

Briefly described, in a preferred embodiment, the present invention overcomes the above-mentioned disadvantages and meets the recognized need for such a device by providing a gaming machine and method of use thereof, wherein the gaming machine comprises of a massage chair, a gaming mechanism enclosed within the massage chair and a gaming display, and wherein the massage chair comprises a seatback, footrest and armrest with padded motorized mechanisms. Additionally, the gaming machine has gaming control buttons that allow a player to place a maximum bet, start a game and collect winnings.

The gaming machine of the present invention combines gaming and relaxation. The massage chair allows a player to sit in a comfortable and relaxing position while also being able to play the gaming device. Further, the player is able to alleviate pain and/or discomfort by relaxing in the massage chair.

According to its major aspects and broadly stated, the present invention in its preferred form is a gaming machine and method of use thereof, wherein the gaming machine comprises a massage chair, a gaming computerized mechanism enclosed within the massage chair, and a gaming display capable of either projecting images either on a fixed display or holographically. The reclinable massage chair has a seatback, reclinable footrest and armrest, each having padded motorized massage mechanisms that can be activated by control buttons on the massage chair. The massage chair's footrest is dimensioned to receive a player's legs and has at least three massage mechanisms, where at least two massage mechanisms are disposed to contact outer portions of the player's legs, and wherein at least one massage mechanism is disposed to contact the rear of the player's legs and at least one massage mechanism is disposed to contact the inner portions of the player's legs.

Additionally, the massage chair has at least one gaming control button and a payment input mechanism, where the payment input mechanism comprises a coin slot, a bill slot and a card slot. Further, attached to the massage chair is a gaming display secured to the massage chair via a rotating mount.

The gaming machine provides a method of gaming by a player taking his or her seat in the massage chair. The player selectively activates massagers built into the massage chair via a control panel. The player then presses a control button on the massage chair to place a maximum bet. Subsequently, the player presses a gaming control button to activate or start a game. The display attached to the massage chair displays the outcome of the game. A credit recorder credits the winnings on an account card of the player via a credit recorder, whereby the player can exchange the account card for cash and/or money. Alternatively, the player presses a control button to collect winnings from a dispenser box on the massage chair.

Thus, the gaming device provides relaxation and comfort by incorporating a gaming mechanism and gaming display within or as part of the massage chair. As such, a player can sit in a comfortable and relaxing position while being massaged, while also being able to play the gaming device.

More specifically, the present invention is a gaming machine having a gaming mechanism, a game display and a massage chair. The gaming mechanism has a gaming computer, a control button panel, a input/output panel and a money dispenser, all of which are in electrical communication.

Additionally, the massage chair is comprised of a neck support, back/neck massagers, a backrest, a seat, a right arm rest, a left arm rest, a lower portion and a footrest. The left arm rest has thereon a dispenser box, a rotational mount, a pivot arm and a holder, and the game display is rotationally disposed on the holder. Further, the holder is disposed on the pivot arm and the pivot arm is disposed on the rotational mount.

The right arm rest comprises a control panel, which is utilized to recline the neck support, the backrest and/or the footrest. The neck support and the backrest each comprise back/neck massagers, wherein the back/neck massagers are selectively controlled via the control panel. The control panel is in electrical communication with the back/neck massagers. The seat comprises a seat massager, which is selectively controlled via the control panel and the control panel is in electrical communication with the seat massager.

The footrest reclines and is retained in a selected position via a support that is disposed between the footrest and the lower portion of the massage chair. The footrest has a base, a left member, a central member, a right member, a right leg groove and a left leg groove. The right leg groove is formed by the base, the right member and the central member. The left leg groove is formed from the base, the left member and the central member.

The base has lower leg massagers, and the right member, the central member and the left member each have side leg massagers. The player sits in the gaming machine and places his or her left and right legs within the left and the right grooves and the player selectively activates massages via the control panel, which is in electrical communication with the lower leg massagers and the side leg massagers. The side leg massagers, namely, the left and right member and the central member could comprise single massagers or a plurality of massagers. The lower leg massagers and the side leg massagers could be any massaging mechanisms, such as, kneading or squeezing devices.

The right arm rest further comprises a first control button, a second control button and a third control button. The first control button is utilized to place a maximum bet, the second control button is utilized to start a game and the third control button is utilized to collect payment of winnings, if applicable. The first, second and third control buttons are in electrical communication with the gaming computer, which comprises the electronics for generation and display of a gambling game.

The payment input/output mechanism and the money dispenser are disposed on the left arm rest, and the control button panel is disposed on the right arm rest. Further, the gaming computer is disposed within the right arm rest. Additionally, arm massagers are disposed within the right and the left arm rests, with activation of the arm massagers selectively controlled by the control panel, which is in electrical communication with the arm massagers. The gaming computer could be disposed within the massage chair either in the left arm rest or in the right arm rest, and the control button panel, the input/output panel and the money dispenser could be disposed elsewhere on the massage chair.

The gaming computer further records receipt of funds via the input/output panel. The input/output panel comprises a payment input/output mechanism, and the payment input/output mechanism controls dispensing of credits via the input/output panel or the dispenser box. The payment input/output mechanism has a coin slot, a card slot and/or a bill slot. The coin slot is dimensioned and adapted to receive coins for game payment, the bill slot is dimensioned and adapted to receive paper money, and the card slot is dimensioned and adapted to receive an account card.

In use, a player sits in the massage chair and places his/her left leg into the left leg groove and place his/her right leg into the right leg groove. The player inserts money or a card into the payment input/output mechanism. The player begins a game by pressing the first control button to place a maximum bet. The player then presses the second gaming button, which activates the game on the game display or a holographic display. The game starts and the game display depicts the results of the play of the game and/or other messages, advertising and/or instructions for play of the game. As the player continues, the gaming computer records money winnings or losses of each game. The player either continues to play or, if applicable, presses the third control button to collect game winnings from the dispenser box or the payment input/output mechanism.

Additionally, the player can selectively activate the back/neck massagers, the arm massagers and/or the seat massager via the control panel. Further, the player's left leg and right leg are selectively massaged by the side leg massagers and the lower leg massagers as selected via the control panel. The player may also recline the neck support, the backrest and/or the footrest for additional comfort via the control panel.

Thus, the gaming machine allows a player to sit in a comfortable and reclining position while also allowing the player to play a gambling game. This provides the player with relaxation, thereby alleviating and preventing discomfort and stress to the player's body. Further, the gaming machine allows a player to play a gambling game while also being massaged on his or her neck, shoulders, back, arms and/or legs. This provides the player with both comfort and entertainment and encourages the player to spend more time playing the game, thereby increasing profits for gaming establishments.

Accordingly, a feature and advantage of the present invention is its ability to allow a player to sit in a comfortable and relaxing position while also being able to play a gaming mechanism.

Another feature and advantage of the present invention is its ability to incorporate a gaming mechanism and/or a gaming display within or as part of a massage chair.

Still another feature and advantage of the present invention is its ability to incorporate a gaming display that is capable of projecting images holographically.

Yet another feature and advantage of the present invention is its ability to massage a player while the player is playing a gaming mechanism.

Yet still another feature and advantage of the present invention is its ability to prevent and/or alleviate a person's shoulder, neck, arm, back and/or leg pain or discomfort.

A further feature and advantage of the present invention is its ability to encourage a player to play a gaming mechanism longer and thereby increase profits to a gaming establishment.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of a gaming machine according to a preferred embodiment of the present invention;

FIG. 2 is a perspective view of a gaming machine according to a preferred embodiment of the present invention, with player shown playing a game; and

FIG. 3 is a rear perspective view of a gaming machine according to an alternate embodiment of the present invention.

### DETAILED DESCRIPTION OF THE PREFERRED AND SELECTED ALTERNATE EMBODIMENTS OF THE INVENTION

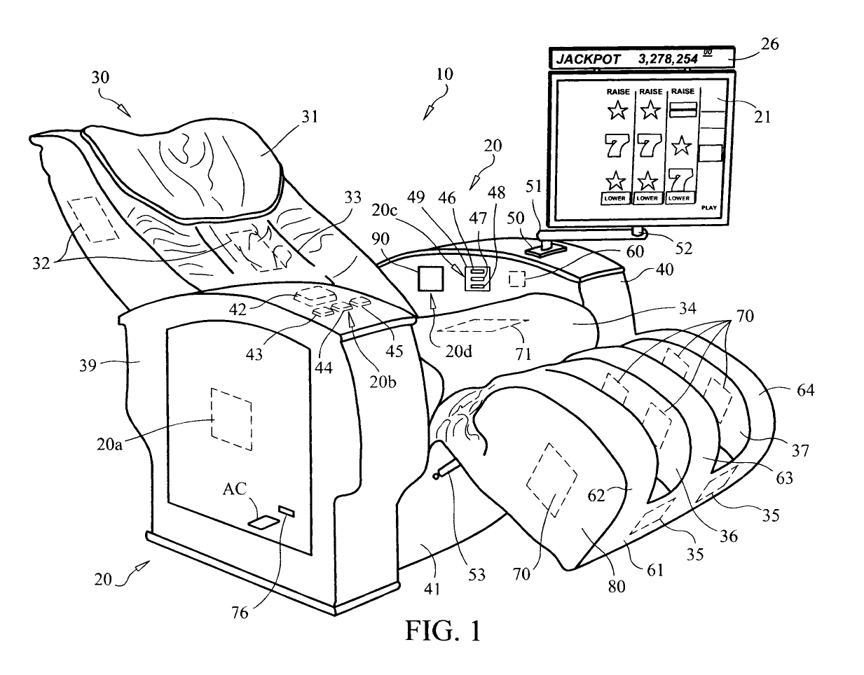

In describing the preferred and selected alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

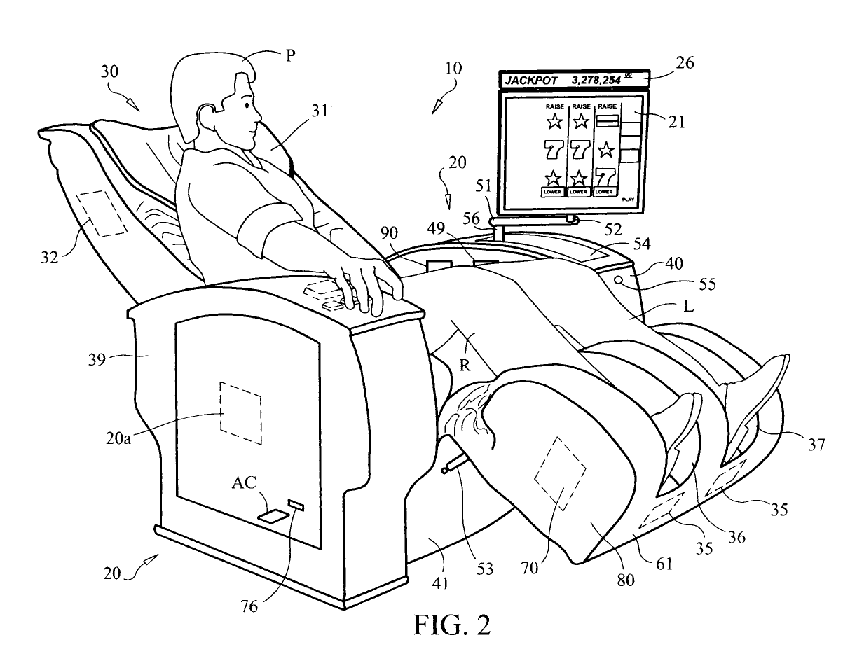

Referring now to FIG. 1-2, the present invention in a preferred embodiment comprises gaming machine 10, wherein gaming machine 10 preferably comprises gaming mechanism 20, game display 21 and massage chair 30, and wherein gaming mechanism 20 preferably comprises gaming computer 20a, control button panel 20b, input/output panel 20c and money dispenser 20d, and wherein gaming computer 20a, control button panel 20b, input/output panel 20c and money dispenser 20d are preferably in electrical communication.

Additionally, massage chair 30 preferably comprises neck support 31, back/neck massagers 32, backrest 33, seat 34, right arm rest 39, left arm rest 40, lower portion 41 and footrest 80, wherein left arm rest 40 preferably comprises dispenser box 90, rotational mount 50, pivot arm 51 and holder 52, and wherein game display 21 is preferably rotationally disposed on holder 52. Gaming machine 10 further comprises jackpot display 26, wherein jackpot display 26 is disposed above, and is secured to, display 21. It will be recognized by those skilled in the art that jackpot display 26 could be disposed other than above display 21 without departing from the spirit of this present invention. Jackpot display 26 comprises, for exemplary purposes only, light emitting diodes (LEDs).

Further, holder 52 is preferably disposed on pivot arm 51, wherein pivot arm 51 is preferably disposed on rotational mount 50.

In an alternate embodiment of the present invention, display 21 could be housed within left armrest 40, wherein upon pressing button 55, display 21 rises out of slot 54 in left armrest 40 on riser rod 56, and wherein riser rod 56 is controlled by a mechanism as such is known in the art for raising a display or similar device. Upon pressing button 55 while display 21 is in view, such activates the mechanism to return display 21 into left armrest 40 via slot 54.

Neck support 31 and backrest 33 each preferably comprise back/neck massagers 32, wherein back/neck massagers 32 are preferably selectively controlled via control panel 42, wherein control panel 42 is preferably in electrical communication with back/neck massagers 32. Seat 34 preferably comprises seat massager 71, wherein seat massager 71 is preferably selectively controlled via control panel 42, and wherein control panel 42 is preferably in electrical communication with seat massager 71.

Right arm rest 39 preferably comprises control panel 42 disposed thereon, wherein control panel 42 is preferably utilized to recline neck support 31, backrest 33 and/or footrest 80. Right arm rest 39 further preferably comprises first control button 43, second control button 44 and third control button 45, wherein first control button 43 is preferably utilized to place a maximum bet, second control button 44 is preferably utilized to start a game and third control button 45 is preferably utilized to collect payment of winnings, if applicable. First, second and third control buttons 43, 44 and 45, respectively, are preferably in electrical communication with gaming computer 20a, wherein gaming computer 20a preferably comprises the electronics as such are known in the art for generation and display of a gambling game. Gaming computer 20a further preferably records receipt of funds via input/output panel 20c, wherein input/output panel 20c preferably comprises payment input/output mechanism 49, and wherein payment input/output mechanism 49 preferably controls dispensing of credits or cash via input/output panel 20c or dispenser box 90, respectively. Payment input/output mechanism 49 preferably comprises coin slot 46, card slot 47 and/or bill slot 48, wherein coin slot 46 is preferably dimensioned and adapted to receive coins for game payment, bill slot 48 is preferably dimensioned and adapted to receive paper money, and card slot 47 is preferably dimensioned and adapted to receive an account card.

Payment input/output mechanism 49 and money dispenser 20d are preferably disposed on left arm rest 40 and control button panel 20b is preferably disposed on right arm rest 40, and, further, gaming computer 20a is preferably disposed within right arm rest 39. Additionally, arm massagers 60 are preferably disposed within right and left arm rest 39 and 40, wherein activation of arm massagers 60 is preferably selectively controlled via control panel 42, and wherein control panel 42 is preferably in electrical communication with arm massagers 60. It will be recognized by those skilled in the art that gaming computer 20a could be disposed within massage chair 30, such as, without limitation, within either left arm rest 40 or right arm rest 39, and that control button panel 20b, input/output panel 20c and money dispenser 20d could be disposed elsewhere on massage chair 30, such as, for exemplary purposes only, in locations on either or both of left arm rest 40 or right arm rest 39.

Right arm rest 39 further comprises security card slot 76, wherein security card slot 76 allows access to computer 20a for servicing/adjustment upon insertion of authorized security access card AC into security card slot 76. Insertion of authorized security access card AC into security card slot 76 further provides access to dispenser box 90 for retrieval of cash, or the event that dispenser box 90 requires additional cash for dispersal, such can be added subsequent to access authorized via authorized security access card AC inserted into security card slot 76.

Footrest 80 preferably reclines and is preferably retained in selected position via support 53, wherein support 53 is preferably disposed between footrest 80 and lower portion 41 of massage chair 30. Footrest 80 preferably comprises base 61, left member 64, central member 63 and right member 62, right leg groove 36 and left leg groove 37, wherein right leg groove 36 is preferably formed by base 61, right member 62 and central member 63, and wherein left leg groove 37 is preferably formed from base 61, left member 64 and central member 63.

Base 61 preferably comprises lower leg massagers 35, and right member 62, central member 63 and left member 64 each preferably comprise side leg massagers 70, wherein when player P is seated in gaming machine 10, his/her left and right legs, L, R are preferably disposed within left and right groove 37, 36, and wherein his/her legs L, R can be preferably selectively massaged via control panel 42, wherein control panel 42 is preferably in electrical communication with lower leg massagers 35 and side leg massagers 70. It will be noted that side leg massagers 70 could comprise single massagers or a plurality of massagers in each of right member 62, central member 63 and/or left member 64. It will further be recognized by those skilled in the art that massagers 35, 70 could comprise any massaging mechanisms known in the art, including, without limitation kneading devices or squeezing devices.

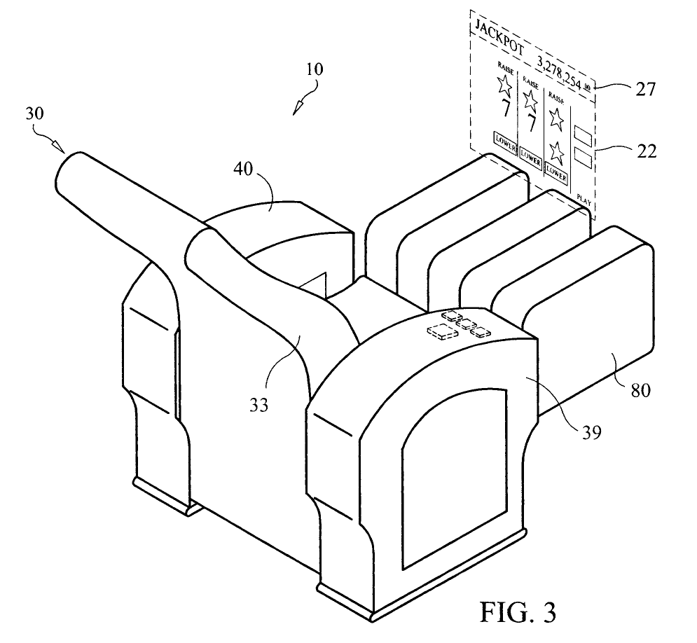

Referring now more specifically to FIG. 3, illustrated therein is an alternate embodiment of device 10, wherein the alternate embodiment of FIG. 3 is substantially equivalent in form and function to that of the preferred embodiment detailed and illustrated in FIGS. 1-2 except as hereinafter specifically referenced. Specifically, in the embodiment of FIG. 3, gaming machine 10 comprises holographic display 22, wherein holographic display 22 is projected in front of massage chair 30 for viewing of a game, instructions or advertisements. Gaming machines 10 could further comprise jackpot display 27 projected either as part of display 22 or separate therefrom.

Referring now to FIGS. 1-3, in use, player P preferably sits in massage chair 30 and places left leg L into left leg groove 37 and places right leg R into right leg groove 36. Player P preferably inserts money or card into payment input/output mechanism 49. Player P preferably begins a game by pressing first control button 43 to place a maximum bet. Player P then preferably presses second gaming button 44, wherein gaming computer 20a preferably activates the game on game display 21 or holographic display 22, and wherein a game starts and game display 21 preferably depicts the results of the play of the game and/or other messages, such as for exemplary purposes only, advertising and/or instructions for play of the game. As P continues, gaming computer 20a preferably records money winnings or losses of each game. Player P either continues to play or, if applicable, presses third control button 45 to collect game winnings from dispenser box 90 or payment input/output mechanism 49.

Additionally, player P can preferably selectively activate back/neck massagers 32, arm massagers 60 and/or seat massager 71 via control panel 42. Further, the player's left leg L and right leg R are preferably selectively massaged by side leg massagers 70 and lower leg massagers 35, also via control panel 42. Player P may also preferably selectively recline neck support 31, backrest 33 and/or footrest 80 for additional comfort via control panel 42.

In an alternate embodiment of the present invention, the massaging function of massage chair 30 could be paid for and timed via game computer 20a. In such event, funds could be deducted from player's account and/or provided via payment input/output mechanism 49.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A gaming machine comprising:
a massage chair;
a gaming mechanism enclosed within said massage chair; and
a gaming display.

2. The gaming machine of claim 1, wherein said massage chair further comprises a rotating mount attached to said massage chair, and wherein said gaming display is rotationally secured to said rotating mount.

3. The gaming machine of claim 1, wherein said massage chair further comprises a reclinable footrest having padded massage mechanisms, and wherein said padded massage mechanisms are dimensioned to receive a player's legs.

4. The gaming machine of claim 1, wherein said gaming display comprises a projected holographic image.

5. The gaming machine of claim 1, wherein said massage chair comprises at least one gaming control button.

6. The gaming machine of claim 1, wherein said massage chair comprises a payment input mechanism.

7. The gaming machine of claim 6, wherein said payment input mechanism comprises a coin slot, a bill slot and a card slot.

8. The gaming machine of claim 1, wherein said massage chair comprises a reclinable footrest, at least one armrest and a seatback.

9. The gaming machine of claim 8, wherein said seatback, said footrest and said at least one armrest each have at least one motorized massage mechanism therewithin.

10. The gaming machine of claim 1, wherein said massage chair is reclinable.

11. The gaming machine of claim 1, further comprising a footrest having at least three massage mechanisms therewithin, wherein at least two of said at least three massage mechanisms are disposed to contact outer portions of a player's legs, and wherein at least one of said at least three massage mechanisms is disposed to contact inner portions of a player's legs.

12. A method of gaming, said method comprising the steps of:
obtaining a massage chair comprising control buttons, a display and a gambling mechanism, wherein said gambling mechanism comprises a money feeder;
placing money into said money feeder;
activating said gambling mechanisms by pressing at least one of said control buttons, wherein said control buttons comprise a first button, a second button and a third button; and
displaying game outcomes on said display.

13. The method of claim 12, wherein said massage chair comprises a credit recorder, said method further comprising the step of:
crediting an account card of a player via said credit recorder, whereby the player can exchange the account card for cash.

14. The method of gaming of claim 12, wherein said massage chair further comprises a dispenser box, said method further comprising of the step of:
dispensing money from said dispenser box.

15. The method of gaming of claim 12, said method comprising the step of:
pressing said first button to place a maximum bet.

16. The method of gaming of claim 12, said method comprising step of:
pressing said second button to start a game.

17. The method of gaming of claim 12, said method comprising the step of:
pressing said third button to collect winnings.

18. The method of gaming of claim 12, further comprising the step of:
massaging a player, wherein the player is seated in said massage chair.

19. The method of gaming of claim 12, wherein said gaming display comprises a holographic image, said method further comprising the step of:
projecting said holographic image.

20. A gaming massage chair comprising:
a reclinable chair section having massaging mechanisms therewithin;
a gambling computer;
control buttons for betting, starting a game and collecting winnings;
a security slot for receiving an authorized security card;
a first display of the game; and
a second display of the jackpot.
